(19) United States
(12) Patent Application Publication
(10) Pub. No.: US 2025/0091662 A1
(43) Pub. Date: Mar. 20, 2025

(54) JOINT STRUCTURE OF VEHICLE BODY

(71) Applicants: Hyundai Motor Company, Seoul (KR); Kia Corporation, Seoul (KR)

(72) Inventors: Won Ki Song, Hwaseong-si (KR); Yongbai Joo, Hwaseong-si (KR); Joonghyun Shin, Hwaseong-si (KR); Jaeseung Lee, Hwaseong-si (KR); Jungsuk Lee, Hwaseong-si (KR); Byung Jin Son, Hwaseong-si (KR); Dae Hee Lee, Hwaseong-si (KR); Jin Ho Hwang, Hwaseong-si (KR); Chulhee Heo, Hwaseong-si (KR); Hyungsik Choi, Hwaseong-si (KR)

(21) Appl. No.: 18/818,720

(22) Filed: Aug. 29, 2024

(30) Foreign Application Priority Data
Sep. 20, 2023 (KR) 10-2023-0125384

(51) Int. Cl. B62D 27/02; B62D 24/00; B62D 25/04; B62D 25/06; B62D 63/02

(52) U.S. Cl. CPC B62D 27/023; B62D 24/00; B62D 25/04; B62D 25/06; B62D 63/025

(57) ABSTRACT

An embodiment joint structure of a vehicle body includes a front body module including a fixed part fixed to a front part of an under body, a rear body module including a variable part that is attachable and detachable to a rear part of the under body and a rear part of the front body module, the rear body module having a predetermined shape, a plurality of fixed part joints mounted at a rear edge of the front body module, and a plurality of variable part joints mounted on a variable part roof rail and a variable part center pillar connected to a front edge of the rear body module, wherein the variable part joints are connected with the fixed part joints.

### CROSS-REFERENCE TO RELATED APPLICATIONS

This application claims the benefit of Korean Patent Application No. 10-2023-0125384, filed on Sep. 20, 2023, which application is hereby incorporated herein by reference.

### TECHNICAL FIELD

The present invention relates to a vehicle body.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle. This PBV can provide various customized services to users while moving from the starting point to the destination in an unmanned autonomous driving method.

The vehicle body of such a PBV is composed of an under body (also referred to as a rolling chassis or a skateboard in the art) and an upper body assembled to the under body.

Here, the upper body may be configured in various forms according to the type of customized service of the PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage room is configured in the rear part.

However, if the structure of the upper body is developed separately according to the various customized services of the PBV as described above, manufacturing costs may increase.

Matters described in this background section are prepared to enhance understanding of the background of embodiments of the invention and may include matters other than already known prior art.

### SUMMARY

The present invention relates to a vehicle body. Particular embodiments relate to a joint structure of a vehicle body, for example, a PBV.

Embodiments of the present disclosure attempts to provide a joint structure of a vehicle body that can be replaced with various types of vehicle bodies according to the type of customized service of the PBV.

A joint structure of a vehicle body according to an exemplary disclosure may include a front body module as a fixed part fixed to a front part of an under body, a rear body module as a variable part attachable and detachable to a rear part of the under body and a rear part of the front body module with a predetermined shape, a plurality of fixed part joints mounted at a rear edge of the front body module, and a plurality of variable part joints mounted on a variable part roof rail and a variable part center pillar connected to a front edge of the rear body module, and the variable part joints are jointly connected with the fixed part joints.

The rear body module may include a variable part roof panel connected to the variable part roof rail and a variable part cover panel connected to the variable part roof rail, the variable part roof panel, and the variable part center pillar.

The variable part joints may be mounted on an inside of a variable part closed-section formed by the variable part roof rail, the variable part roof panel, the variable part center pillar, and the variable part cover panel.

The fixed part joints may be connected to the variable part joints through passing holes formed in the variable part cover panel.

The rear body module may further include a sealing plug mounted on the variable part cover panel to seal between edges of the passing holes and the fixed part joints.

The front body module may include a fixed part roof rail and a fixed part center pillar connected to the rear edge thereof, a fixed part roof panel connected to the fixed part roof rail, and a fixed part cover panel connected to the fixed part roof rail, the fixed part roof panel, and the fixed part center pillar.

The fixed part joints may be mounted on the fixed part cover panel on an outside of a fixed part closed-section formed by the fixed part roof rail, the fixed part roof panel, the fixed part center pillar, and the fixed part cover panel.

The front body module may further include a plurality of fixed part bulk heads mounted on the inner side of the fixed part closed-section and connected to the fixed part joints.

The fixed part bulk heads may be connected to the fixed part roof rail and the fixed part cover panel on the upper side of the front body module.

The fixed part bulk heads may be connected to the fixed part center pillar and the fixed part cover panel on the side of the front body module.

The rear body module may further include a plurality of variable part bulk heads mounted on the inside of the variable part closed-section and connected to the variable part joints on the inside of the variable part closed-section.

The variable part bulk heads may be connected to the variable part roof rail, the variable part roof panel, and the variable part cover panel on the upper side of the rear body module.

The variable part bulk heads may be connected to the variable part center pillar and the variable part cover panel on the side of the rear body module.

A joint structure of a vehicle body according to an exemplary disclosure may include a front body module as a fixed part fixed to a front part of an under body, a rear body module as a variable part attachable and detachable to a rear part of the under body and a rear part of the front body module with a predetermined shape, a plurality of fixed part joints mounted at a rear edge of the front body module, a plurality of variable part joints mounted on a variable part roof rail and a variable part center pillar connected to a front edge of the rear body module, and the variable part joints jointly connected with the fixed part joints, and a variable part reinforcement unit connected to the variable part roof rail and the variable part center pillar.

The variable part reinforcement unit may include a main rail extension member connected to both ends of the variable part roof rail in the vehicle width direction and connected to the variable part center pillar, a roof side member connected to the main rail extension member along the front and back direction of the vehicle body, and a sub-rail extension member connected to the main rail extension member, the roof side member, and the variable part center pillar.

The roof side member may include a flange portion connected to the main rail extension member and may have a closed cross-section of square shape.

The variable part reinforcement unit may include a pillar extension member connected to the lower part of the variable part center pillar and connected to the variable part floor panel.

The joint structure of a vehicle body according to an exemplary disclosure may further include a floor extension member connected to a variable part cross member formed on the variable part floor panel and connected to the pillar extension member.

The joint structure of a vehicle body according to an exemplary disclosure may further include a fixed part joint reinforcement unit mounted on the rear edge of the front body module and a variable part joint reinforcement unit mounted on the front edge of the rear body module.

According to embodiments of the disclosure, cost savings can be achieved by configuring the vehicle body to suit the various customized services of the PBV.

In addition, according to embodiments of the disclosure, the connection strength and skeletal strength of the front body module and rear body module that are detachable from each other can be secured, and the mounting strength of the joint structure can be secured.

In addition, the effects that can be obtained or predicted from an exemplary embodiment will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are for reference in explaining exemplary embodiments of the present invention, the technical idea of the present invention should not be construed as being limited to the accompanying drawings.

FIG. 1 is an exploded perspective view showing a joint structure of a vehicle body according to an exemplary embodiment.

FIG. 2 is an exploded perspective view showing a front body module and a rear body module applied to the joint structure of a vehicle body according to an exemplary embodiment.

FIG. 3 is a perspective view showing the front body module applied to the joint structure of a vehicle body according to an exemplary embodiment.

FIG. 4 is an exploded perspective view showing the front body module applied to the joint structure of a vehicle body according to an exemplary embodiment.

FIG. 5 is a cross-sectional view along line A-A in FIG. 3.

FIG. 6 is a cross-sectional view along line B-B in FIG. 3.

FIG. 7 is a perspective view showing a rear body module applied to the joint structure of a vehicle body according to an exemplary embodiment.

FIG. 8 is an exploded perspective view showing a rear body module applied to the joint structure of a vehicle body according to an exemplary embodiment.

FIG. 9 is a cross-sectional view along line C-C in FIG. 7.

FIG. 10 is a cross-sectional view along line D-D in FIG. 7.

FIG. 11A to FIG. 12B are drawings showing a connecting structure of the front body module and rear body module applied to the joint structure of a vehicle body according to an exemplary embodiment.

FIG. 13A and FIG. 13B are drawings showing a variable part reinforcement unit of the rear body module applied to the joint structure of a vehicle body according to an exemplary embodiment.

The following reference identifiers may be used in connection with the drawings to describe various features of embodiments of the present invention.

| | |
|---|---|
| 1: under body | 3: upper body |
| 10: front body module | 10a: fixed part |
| 11: fixed part center pillar | 13: fixed part roof panel |
| 15: fixed part roof rail | 17: fixed part cover panel |
| 19: fixed part closed-section | 20: fixed part joint |
| 30: fixed part joint reinforcement | 31: fixed part bulk head |
| unit | |
| 40: rear body module | 40a: variable part |
| 41: variable part roof panel | 43: variable part floor panel |
| 44a: variable part cross member | 44b: floor extension member |
| 45: variable part roof rail | 46: variable part center pillar |
| 47: variable part cover panel | 48: passing hole |
| 49: variable part closed-section | 50: variable part joint |
| 55: sealing plug | 60: variable part joint reinforcement |
| | unit |
| 61: variable part bulk head | 70: variable part reinforcement unit |
| 71: main rail extension member | 73: roof side member |
| 75: sub- rail extension member | 77: pillar extension member |
| 81: closed cross-section | 83: flange portion |
| 100: vehicle body joint structure | |

The drawings referenced above are not necessarily drawn to scale, but they should be understood as presenting a somewhat simplified representation of various preferred features illustrating the basic principles of embodiments of the present invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the present invention. As those skilled in the art would realize, the described embodiments may be modified in various different ways, all without departing from the spirit or scope of the present invention.

The terminology used herein is for the purpose of describing specific disclosures only and is not intended to limit the disclosure. As used herein, singular forms are intended to also include plural forms, unless the context clearly indicates otherwise.

As used herein, the terms ‘comprise’ and/or ‘comprising’ indicate the presence of specified features, integers, steps, operations, elements, and/or components, but they may also include, and do not exclude the presence or addition of, one or more other features, integers, steps, operations, elements, components, and/or groups thereof.

As used herein, the term ‘and/or’ includes any one or all combinations of one or more items listed in association.

In this specification, the term ‘connected,’ ‘combined’ and so on indicates a physical relationship between two components in which the components are directly connected to each other by welding, rivets, self piercing rivet (SPR), flow drill screw (FDS), structural adhesive, etc., or indirectly connected through one or more intermediate components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

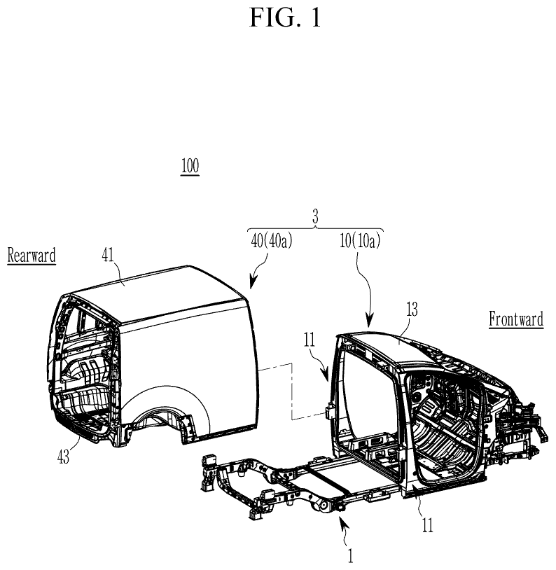

FIG. 1 is an exploded perspective view showing a joint structure of a vehicle body according to an exemplary embodiment.

Referring to FIG. 1, according to an exemplary embodiment, a vehicle body joint structure 100 may be applied, for example, to a purpose-based mobility vehicle (hereinafter referred to as a ‘PBV’).

The PBV may be used as an electric vehicle-based life module vehicle that provides various services to occupants while moving from one place to a destination in an unmanned self-driving manner.

In one example, the PBV may be manufactured in a one box type design with a large interior space. The PBV may also apply facing type seats to the interior space.

The vehicle body of such a PBV is suitable for small quantity production of various vehicle types with a small number of parts, and it may be manufactured in various shapes and sizes.

The vehicle body of the PBV includes a skateboard type under body 1 (commonly referred to as a ‘rolling chassis’ or ‘chassis frame’ by those skilled in the art) and an upper body 3 assembled to the under body 1.

The under body 1 may be equipped with components such as a battery assembly and a drive motor. Additionally, the upper body 3 may include a spacious cabin and a luggage room.

In this specification, the ‘front to rear direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

In this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The vehicle body joint structure 100 according to an exemplary embodiment may be a structure that can apply various types of the upper body 3 to the under body 1 according to the type of customized service of the PBV.

The vehicle body joint structure 100 according to an exemplary embodiment includes a front body module 10 and a rear body module 40 as the upper body 3.

In an exemplary embodiment, the front body module 10 includes a front cabin of a cab type. The front body module 10 may be fixed to the front part of the under body 1.

The front body module 10 may be connected to a front part of the under body 1 along a vertical direction through a vehicle body mounting unit known to a person of ordinary skill in the art. The front body module 10 may be provided as a fixed part 10a fixed to the front part of the under body 1.

The front body module 10 as described above includes a front side structure, a front roof structure, and a front floor structure that are combined with each other.

The front side structure may include a fixed part center pillar 11. The fixed part center pillar 11 is disposed on both sides of the vehicle in the vehicle width direction at the rear edge of the front body module 10.

The front roof structure may include a fixed part roof panel 13.

In embodiments, the rear body module 40 includes a rear cabin or a luggage room. The rear body module 40 is removably provided at the rear of the under body 1 and the rear of the front body module 10.

The rear body module 40 can be attached and detached from the rear part of the under body 1 along the vertical direction. Additionally, the rear body module 40 can be attached to or detached from the rear of the front body module 10 along the front-to-rear direction of the vehicle body. The rear body module 40 can be manufactured in various shapes depending on the purpose of the PBV.

The rear body module 40 may be provided as a detachable variable part 40a at the rear of the under body 1 and the rear of the front body module 10.

The rear body module 40 may form a rear cabin at the rear of the vehicle body. Additionally, the rear body module 40 may form a hailing type upper body 3 together with the front body module 10.

Additionally, the rear body module 40 may form a luggage room at the rear of the vehicle body. Additionally, the rear body module 40 may form a delivery type upper body 3 together with the front body module 10.

The rear body module 40 as described above includes a rear side structure, a rear roof structure, and a rear floor structure that are combined with each other.

The rear roof structure may include a variable part roof panel 41.

The rear floor structure may include a variable part floor panel 43.

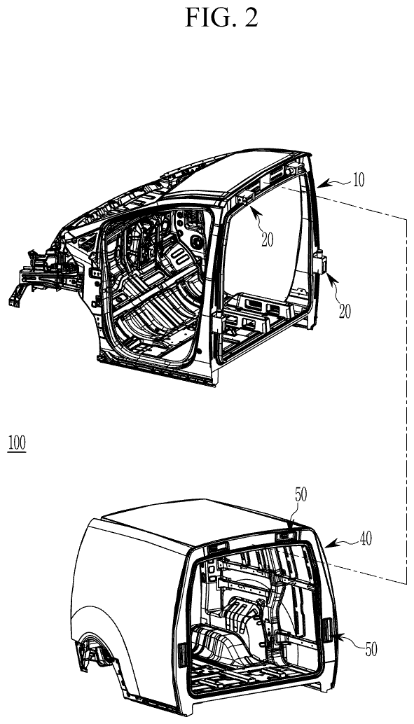

FIG. 2 is an exploded perspective view showing a front body module and a rear body module applied to the joint structure of a vehicle body according to an exemplary embodiment.

Referring to FIG. 1 and FIG. 2, according to an embodiment, the vehicle body joint structure 100 further includes a plurality of fixed part joints 20 and a plurality of variable part joints 50.

The fixed part joints 20 and the variable part joints 50 are configured to attach and detach the front body module 10 and the rear body module 40 along the front and rear direction of the vehicle body.

The fixed part joints 20 are mounted on the rear edge of the front body module 10. And, the variable part joints 50 are mounted on the front edge of the rear body module 40.

The fixed part joints 20 and the variable part joints 50 can be connected to each other or separated from each other. In one example, the fixed part joints 20 and the variable part joints 50 can be mechanically locked or unlocked by manual or automatic methods.

In another example, the fixed part joints 20 and the variable part joints 50 may be locked or unlocked mechanically and may also be locked or unlocked by magnetic force and electromagnetic force.

In another such example, the fixed part joints 20 may include a magnetic module including combinations of a circular magnet, a linear magnet, a coil, and a locking member that rotates by operation of a motor. In addition, the variable part joints 50 are locked or unlocked with the fixed part joints 20 by the magnetic force and the electromagnetic force generated from the fixed part joints 20, and the armature block (e.g., steel block) is mechanically locked or unlocked with the locking member.

In addition, the fixed part joints 20 and the variable part joints 50 may be structured so that they can be mutually locked or unlocked in various ways that are obvious to those skilled in the art.

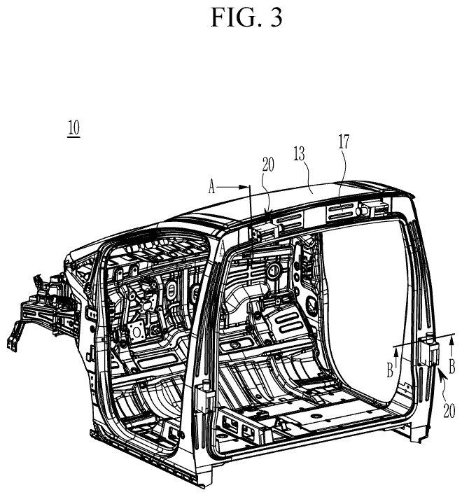

Hereinafter, referring to FIG. 3 to FIG. 6, the mounting structure of the fixed part joints 20 for the front body module 10 will be explained in detail.

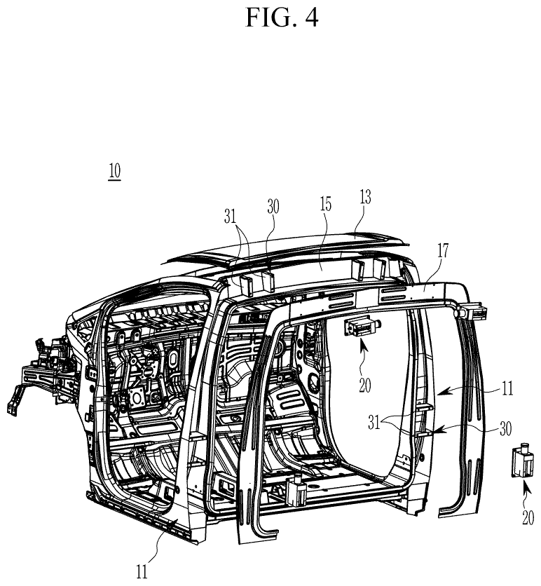

FIG. 3 is a perspective view showing the front body module applied to the joint structure of a vehicle body according to an exemplary disclosure, and FIG. 4 is an exploded perspective view showing the front body module applied to the joint structure of a vehicle body according to an exemplary disclosure.

Referring to FIG. 3 and FIG. 4, the front body module 10 according to an embodiment includes a fixed part roof rail 15 and a fixed part cover panel 17.

The fixed part roof rail 15 is disposed along the vehicle width direction at the rear edge of the front body module 10. The fixed part roof rail 15 is connected to the upper part of the fixed part center pillar 11. And, the fixed part roof rail 15 is combined with the fixed part roof panel 13. In one example, the fixed part roof rail 15 may be provided in an ‘L’ cross-section shape.

The fixed part cover panel 17 is combined with the fixed part center pillar 11, the fixed part roof panel 13, and the fixed part roof rail 15.

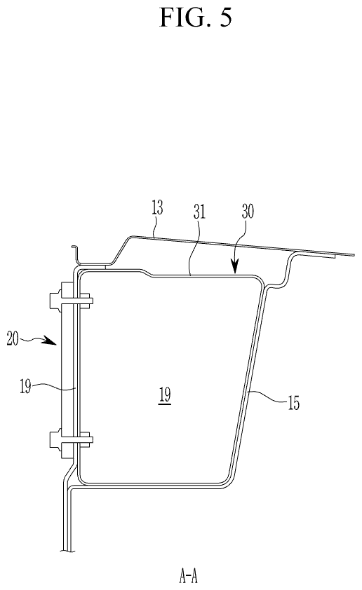

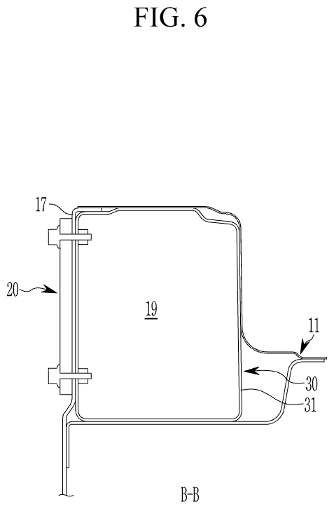

FIG. 5 is a cross-sectional view along line A-A in FIG. 3, and FIG. 6 is a cross-sectional view along line B-B in FIG. 3.

As shown in FIG. 5 and FIG. 6, the fixed part center pillar 11, the fixed part roof panel 13, the fixed part roof rail 15, and the fixed part cover panel 17 connected with each other may form a fixed part closed-section 19. And, the fixed part joints 20 may be mounted on the fixed part cover panel 17, on the outside of the fixed part closed-section 19.

The front body module 10 according to an embodiment of the present invention further includes a fixed part joint reinforcement unit 30 mounted at the rear edge thereof.

The fixed part joint reinforcement unit 30 is configured to mount the fixed part joints 20 on the fixed part cover panel 17 on the outside of the fixed part closed-section 19. And, the fixed part joint reinforcement unit 30 is configured to secure the mounting strength of the fixed part joints 20 and disperse the load concentrated on the fixed part joints 20.

The fixed part joint reinforcement unit 30 includes a plurality of fixed part bulk heads 31 mounted on the inside of the fixed part closed-section 19. The fixed part bulk heads 31 are connected to the fixed part joints 20 with the fixed part cover panel 17 in between.

As shown in FIG. 5, the fixed part bulk heads 31 are connected to the fixed part roof rail 15 and the fixed part cover panel 17 on the upper side of the front body module 10.

As shown in FIG. 6, the fixed part bulk heads 31 are connected to the fixed part center pillar 11 and the fixed part cover panel 17 on the side of the front body module 10.

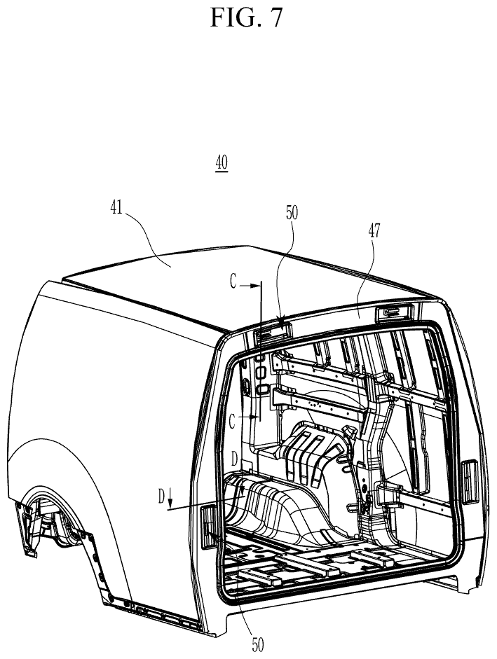

Hereinafter, referring to FIG. 7 to FIG. 10, the mounting structure of the variable part joints 50 for the rear body module 40 will be explained in detail.

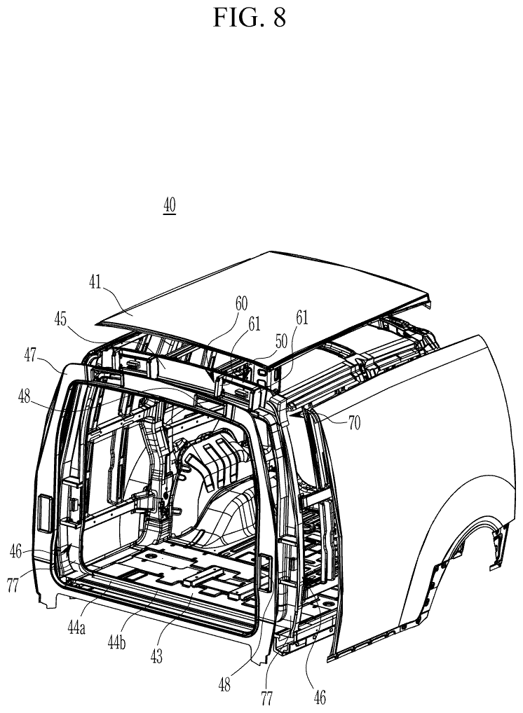

FIG. 7 is a perspective view showing a rear body module applied to the joint structure of a vehicle body according to an exemplary disclosure, and FIG. 8 is an exploded perspective view showing a rear body module applied to the joint structure of a vehicle body according to an exemplary disclosure.

Referring to FIG. 7 and FIG. 8, the rear body module 40 according to an embodiment includes a variable part roof rail 45, a variable part center pillar 46, and a variable part cover panel 47.

The variable part roof rail 45 is disposed along the vehicle width direction at the front edge of the rear body module 40. The variable part center pillar 46 is disposed on both sides of the vehicle in the vehicle width direction at the front edge of the rear body module 40.

The variable part roof rail 45 is connected to the upper part of the variable part center pillar 46. And, the variable part roof rail 45 is connected to the variable part roof panel 41. In one example, this variable part roof rail 45 may be provided in an ‘L’ cross-section shape.

The variable part cover panel 47 is connected to the variable part roof panel 41, the variable part roof rail 45, and the variable part center pillar 46.

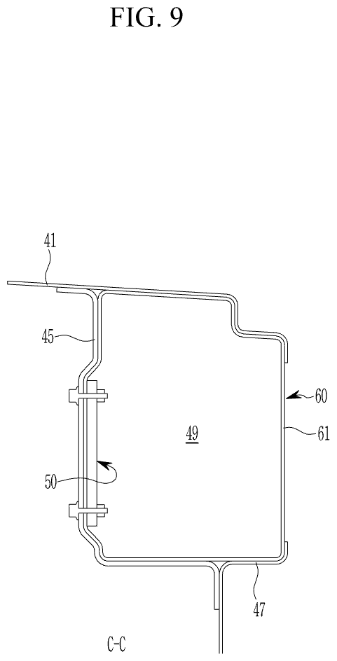

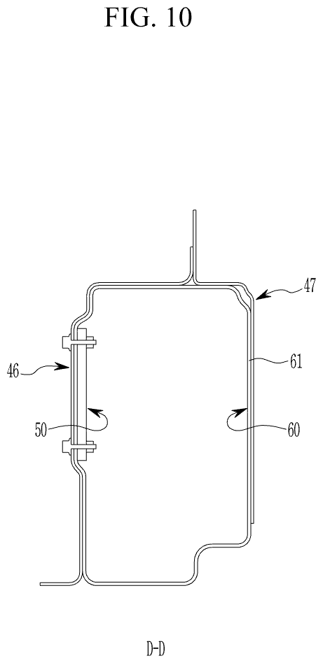

FIG. 9 is a cross-sectional view along line C-C in FIG. 7, and FIG. 10 is a cross-sectional view along line D-D in FIG. 7.

As shown in FIG. 9 and FIG. 10, the variable part roof panel 41, the variable part roof rail 45, the variable part center pillar 46, and the variable part cover panel 47 connected to each other may form a variable part closed-section 49.

And, the variable part joints 50 are mounted on the inside of the variable part closed-section 49. That is, the variable part joints 50 are mounted on the variable part roof rail 45 and the variable part center pillar 46 on the inside of the variable part closed-section 49.

Referring to FIG. 7 to FIG. 10, the rear body module 40 according to an embodiment further includes a variable part joint reinforcement unit 60 mounted at the front edge thereof.

The variable part joint reinforcement unit 60 is configured to mount the variable part joints 50 on the inner side of the variable part closed-section 49. And, the variable part joint reinforcement unit 60 is configured to secure the mounting strength of the variable part joints 50 and to disperse the load concentrated on the variable part joints 50.

The variable part joint reinforcement unit 60 includes a plurality of variable part bulk heads 61 mounted on the inside of the variable part closed-section 49. The variable part bulk heads 61 are connected to the variable part joints 50 on the inside of the variable part closed-section 49.

As shown in FIG. 9, the variable part bulk heads 61 are connected to the variable part roof panel 41, the variable part roof rail 45, and the variable part cover panel 47 on the upper side of the rear body module 40.

As shown in FIG. 10, the variable part bulk heads 61 are connected to the variable part center pillar 46 and the variable part cover panel 47 on the side of the rear body module 40.

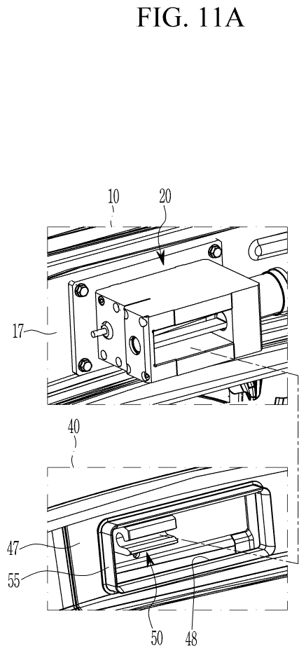

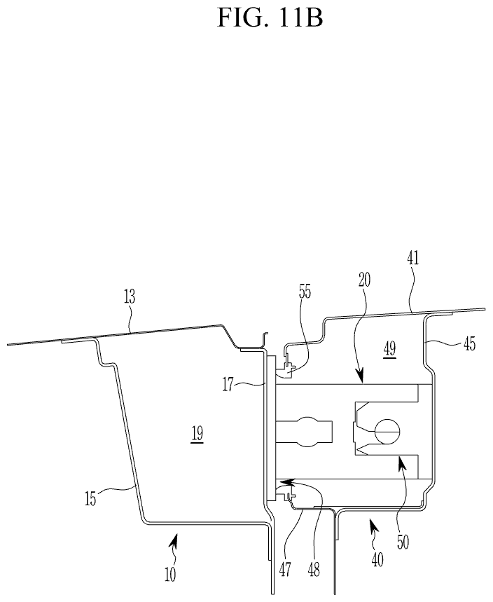

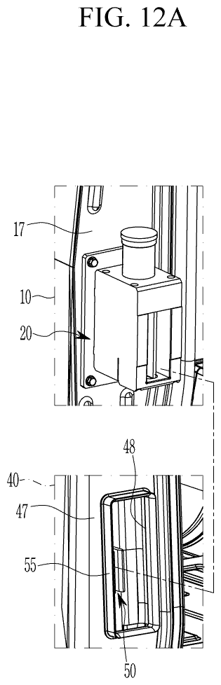

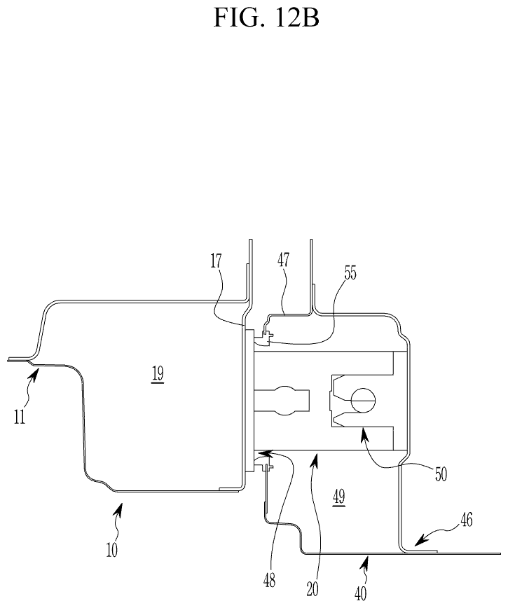

FIG. 11A to FIG. 12B are drawings showing a connecting structure of the front body module and the rear body module applied to the joint structure of a vehicle body according to an embodiment.

Referring to FIG. 11A to FIG. 12B, a plurality of passing holes 48 are formed to the variable part cover panel 47. The passing holes 48 are formed in positions corresponding to the variable part joints 50.

The front body module 10 and the rear body module 40 according to an embodiment of the present invention may be connected along the front-rear direction of the vehicle body by the fixed part joints 20 and the variable part joints 50.

That is, the fixed part joints 20 are inserted into the passing holes 48 of the variable part cover panel 47 along the front-to-back direction of the vehicle body. Accordingly, the fixed part joints 20 may be jointly connected with the variable part joints 50 on the inside of the variable part closed-section 49.

As shown in FIG. 11B and FIG. 12B, some of the fixed part joints 20 are connected to the fixed part cover panel 17 on the outside of the fixed part closed-section 19 formed by the fixed part roof panel 13, the fixed part roof rail 15, and the fixed part cover panel 17.

Additionally, some of the variable part joints 50 are connected to the inside of the variable part closed-section 49 formed by the variable part roof panel 41, the variable part roof rail 45, and the variable part cover panel 47.

Therefore, part of the fixed part joints 20 can be jointly connected to part of the variable part joints 50 through the passing holes 48 of the variable part cover panel 47.

Additionally, the remainder of the fixed part joints 20 are connected to the fixed part cover panel 17 on the outside of the fixed part closed-section 19 formed by the fixed part center pillar 11 and the fixed part cover panel 17.

And, the remainder of the variable part joints 50 are connected to the inside of the variable part closed-section 49 formed by the variable part center pillar 46 and the variable part cover panel 47.

Therefore, the remainder of the fixed part joints 20 can be jointly connected with the remainder of the variable part joints 50 through the passing holes 48 of the variable part cover panel 47.

Furthermore, the rear body module 40 further includes a sealing plug 55. The sealing plug 55 is mounted on the edge of the passing holes 48 in the variable part cover panel 47.

The sealing plug 55 is configured to seal between the edges of the passing holes 48 and the fixed part joints 20. The sealing plug 55 may, in one example, be formed of a rubber material.

Referring to FIG. 8, the rear body module 40 according to an embodiment of the present invention further includes a variable part reinforcement unit 70 connected to the variable part roof rail 45 and the variable part center pillar 46.

The variable part reinforcement unit 70 is configured to reinforce the skeletal strength of the rear body module 40 and the mounting strength of the variable part joints 50 and to form a closed-shaped load path at the front edge of the rear body module 40. And, the variable part reinforcement unit 70 is configured to form a load pass along the front and rear direction of the vehicle body at the front edge portion of the rear body module 40.

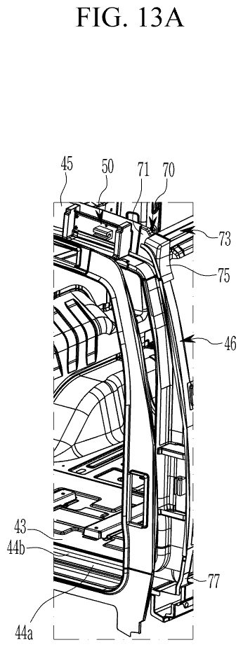

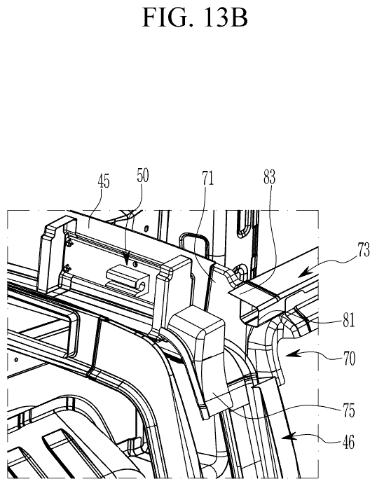

FIG. 13A and FIG. 13B are drawings showing a variable part reinforcement unit of the rear body module applied to the joint structure of a vehicle body according to an embodiment.

Referring to FIG. 8, FIG. 13A, and FIG. 13B, the variable part reinforcement unit 70 according to an embodiment may include a main rail extension member 71, a roof side member 73, a sub-rail extension member 75, and a pillar extension member 77.

The main rail extension member 71 is connected to both ends of the variable part roof rail 45 in the vehicle width direction, respectively. The main rail extension member 71 is connected to the variable part center pillar 46.

The roof side member 73 is connected to the main rail extension member 71 along the front and rear direction of the vehicle body. The roof side member 73, in one example, includes a closed cross-section 81 of square shape and a flange portion 83 connected to the main rail extension member 71.

The sub-rail extension member 75 is connected to the main rail extension member 71, the roof side member 73, and the variable part center pillar 46.

And, the pillar extension member 77 is connected to the lower part of the variable part center pillar 46 and the variable part floor panel 43. The pillar extension member 77 is connected to a floor extension member 44b, which is connected to a variable part cross member 44a formed on the variable part floor panel 43.

Hereinafter, the operation of the vehicle body joint structure 100 configured as above will be described referring to FIG. 1 to FIG. 13B.

First, in an embodiment, on the outside of the fixed part closed-section 19 of the front body module 10, the fixed part joints 20 are connected to the fixed part cover panel 17.

Additionally, in an embodiment, the variable part joints 50 are connected to the inner side of the variable part closed-section 49 of the rear body module 40.

Here, the front body module 10 is fixed to the front part of the under body 1. And, as described above, the rear body module 40 is separated from the front body module 10.

In this state, the rear body module 40 moves from the rear side of the under body 1 to the lower direction and moves toward the front body module 10.

Then, the fixed part joints 20 are inserted from the rear side into the passing holes 48 of the variable part cover panel 47. Accordingly, the fixed part joints 20 are jointly connected with the variable part joints 50 on the inside of the variable part closed-section 49.

Here, the space between the edge of the passing holes 48 connected to the inside of the variable part closed-section 49 and the fixed part joints 20 is sealed by the sealing plug 55.

Therefore, the fixed part joints 20 and the variable part joints 50 connected to each other are embedded inside the variable part closed-section 49 and are not exposed to the outside.

As a result, the vehicle body joint structure 100 according to an embodiment can prevent the fixed part joints 20 and the variable part joints 50 from being contaminated by foreign substances such as dust.

In addition, in the vehicle body joint structure 100 according to an embodiment, as the sealing plug 55 closes and seals the variable part closed-section 49, watertight performance can be improved.

Meanwhile, in an embodiment, the fixed part bulk heads 31 connected to the fixed part joints 20 are mounted on the inner side of the fixed part closed-section 19.

Here, the fixed part bulk heads 31 are connected to the fixed part roof rail 15 and the fixed part cover panel 17, and the fixed part roof rail 15 and the fixed part cover panel 17 are connected to the fixed part roof panel 13.

And, the fixed part bulk heads 31 are connected to the fixed part center pillar 11 and the fixed part cover panel 17.

Therefore, a closed cross-section of a square shape may be formed at the area where the fixed part joints 20 are connected.

As a result, the vehicle body joint structure 100 according to an embodiment can disperse the load concentrated on the fixed part joints 20 while securing the mounting strength of the fixed part joints 20.

Additionally, the fixed part bulk heads 31 can block moisture inflow into the fixed part roof rail 15 and the fixed part center pillar 11.

On the other hand, in an embodiment, the variable part bulk heads 61 connected to the variable part joints 50 are mounted on the inside of the variable part closed-section 49.

Here, the variable part bulk heads 61 are connected to the variable part roof panel 41, the variable part roof rail 45, and the variable part cover panel 47. And, the variable part bulk heads 61 are connected to the variable part center pillar 46 and the variable part cover panel 47.

Therefore, a closed cross-section of a square shape may be formed at the area where the variable part joints 50 are connected.

As a result, the vehicle body joint structure 100 according to an embodiment can disperse the load concentrated on the variable part joints 50 while securing the mounting strength of the variable part joints 50.

Additionally, the variable part bulk heads 61 can block moisture inflow into the variable part roof rail 45 and the variable part center pillar 46.

On the other hand, in an embodiment, the variable part reinforcement unit 70 connected to the variable part roof rail 45 and the variable part center pillar 46 is provided.

The variable part reinforcement unit 70 may form a closed-shaped load path at the front edge of the rear body module 40 and may form a load path along the front and rear directions of the vehicle body.

Therefore, the variable part reinforcement unit 70 can increase the skeletal strength of the rear body module 40 and the mounting strength of the variable part joints 50.

According to the vehicle body joint structure 100 with the front body module 10 as the fixed part 10a connected to the front part of the under body 1, the rear body module 40 as the variable part 40a can be connected to the rear part of the under body 1 and the rear part of front body module 10.

Therefore, according to an embodiment, the vehicle body joint structure 100 replaces the rear body module 40 of a predetermined shape, depending on the type of customized service (e.g., use case) of the PBV, and thus, the PBV can be used as a hailing type or a delivery type vehicle.

As a result, the vehicle body joint structure 100 according to an embodiment may reduce costs due to changing the structure of the upper body 3 of the vehicle body to suit the various customized services of the PBV.

Furthermore, the vehicle body joint structure 100 according to an embodiment may smoothly disperse the load input to the front body module 10 and the rear body module 40 that are connected to each other, thereby improving the collision performance and torsional strength of the vehicle body.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A joint structure of a vehicle body, the joint structure comprising:
a front body module comprising a fixed part fixed to a front part of an under body;
a rear body module comprising a variable part that is attachable and detachable to a rear part of the under body and a rear part of the front body module, the rear body module having a predetermined shape;
a plurality of fixed part joints mounted at a rear edge of the front body module; and
a plurality of variable part joints mounted on a variable part roof rail and a variable part center pillar connected to a front edge of the rear body module, wherein the variable part joints are connected with the fixed part joints.

2. The joint structure of claim 1, wherein the rear body module comprises:
a variable part roof panel connected to the variable part roof rail; and
a variable part cover panel connected to the variable part roof rail, the variable part roof panel, and the variable part center pillar.

3. The joint structure of claim 2, wherein the variable part joints are mounted on an inside of a variable part closed-section defined by the variable part roof rail, the variable part roof panel, the variable part center pillar, and the variable part cover panel.

4. The joint structure of claim 3, wherein the fixed part joints are connected to the variable part joints through passing holes disposed in the variable part cover panel.

5. The joint structure of claim 4, wherein the rear body module further comprises a sealing plug mounted on the variable part cover panel to seal between edges of the passing holes and the fixed part joints.

6. The joint structure of claim 3, wherein the rear body module further comprises a plurality of variable part bulk heads mounted on the inside of the variable part closed-section and connected to the variable part joints on the inside of the variable part closed-section.

7. The joint structure of claim 6, wherein the variable part bulk heads are connected to the variable part roof rail, the variable part roof panel, and the variable part cover panel on an upper side of the rear body module and are connected to the variable part center pillar and the variable part cover panel on a side of the rear body module.

8. The joint structure of claim 1, wherein the front body module comprises:
a fixed part roof rail and a fixed part center pillar connected to the rear edge of the front body module;
a fixed part roof panel connected to the fixed part roof rail; and
a fixed part cover panel connected to the fixed part roof rail, the fixed part roof panel, and the fixed part center pillar.

9. The joint structure of claim 8, wherein the fixed part joints are mounted on the fixed part cover panel on an outside of a fixed part closed-section defined by the fixed part roof rail, the fixed part roof panel, the fixed part center pillar, and the fixed part cover panel.

10. The joint structure of claim 9, wherein the front body module further comprises a plurality of fixed part bulk heads mounted on an inner side of the fixed part closed-section and connected to the fixed part joints.

11. The joint structure of claim 10, wherein the fixed part bulk heads are connected to the fixed part roof rail and the fixed part cover panel on an upper side of the front body module and are connected to the fixed part center pillar and the fixed part cover panel on a side of the front body module.

12. A joint structure of a vehicle body, the joint structure comprising:
a front body module comprising a fixed part fixed to a front part of an under body;
a rear body module comprising a variable part attachable and detachable to a rear part of the under body and a rear part of the front body module, the rear body module having a predetermined shape;
a plurality of fixed part joints mounted at a rear edge of the front body module;
a plurality of variable part joints mounted on a variable part roof rail and a variable part center pillar connected to a front edge of the rear body module, wherein the variable part joints are connected with the fixed part joints; and
a variable part reinforcement unit connected to the variable part roof rail and the variable part center pillar.

13. The joint structure of claim 12, wherein the variable part reinforcement unit comprises:
a main rail extension member connected to both ends of the variable part roof rail in a vehicle width direction and connected to the variable part center pillar;
a roof side member connected to the main rail extension member along a front and back direction of the vehicle body; and
a sub-rail extension member connected to the main rail extension member, the roof side member, and the variable part center pillar.

14. The joint structure of claim 13, wherein the roof side member comprises a flange portion connected to the main rail extension member and has a closed cross-section of a square shape.

15. The joint structure of claim 14, wherein the variable part reinforcement unit comprises a pillar extension member connected to a lower part of the variable part center pillar and connected to a variable part floor panel.

16. The joint structure of claim 15, further comprising a floor extension member connected to a variable part cross member disposed on the variable part floor panel and connected to the pillar extension member.

17. The joint structure of claim 12, further comprising:
a fixed part joint reinforcement unit mounted on the rear edge of the front body module; and
a variable part joint reinforcement unit mounted on the front edge of the rear body module.

18. A vehicle comprising:
a vehicle body comprising an under body and an upper body coupled to the under body, wherein the upper body comprises:
a front body module comprising a fixed part coupled to a front part of the under body;
a rear body module having a predetermined shape and comprising a variable part that is detachably coupled to a rear part of the under body and a rear part of the front body module, the rear body module comprising:
a variable part roof rail connected to a front edge of the rear body module;
a variable part roof panel connected to the variable part roof rail;
a variable part center pillar connected to the front edge of the rear body module; and
a variable part cover panel connected to the variable part roof rail, the variable part roof panel, and the variable part center pillar;
a plurality of fixed part joints mounted at a rear edge of the front body module; and
a plurality of variable part joints mounted on the variable part roof rail and the variable part center pillar, wherein the variable part joints are connected with the fixed part joints.

19. The vehicle of claim 18, wherein the front body module comprises:
a fixed part roof rail and a fixed part center pillar connected to the rear edge of the front body module;
a fixed part roof panel connected to the fixed part roof rail; and
a fixed part cover panel connected to the fixed part roof rail, the fixed part roof panel, and the fixed part center pillar.

20. The vehicle of claim 19, wherein:
the variable part joints are mounted on an inside of a variable part closed-section defined by the variable part roof rail, the variable part roof panel, the variable part center pillar, and the variable part cover panel;
the rear body module further comprises a plurality of variable part bulk heads mounted on the inside of the variable part closed-section and connected to the variable part joints on the inside of the variable part closed-section;
the variable part bulk heads are connected to the variable part roof rail, the variable part roof panel, and the variable part cover panel on an upper side of the rear body module and are connected to the variable part center pillar and the variable part cover panel on a side of the rear body module;
the fixed part joints are mounted on the fixed part cover panel on an outside of a fixed part closed-section defined by the fixed part roof rail, the fixed part roof panel, the fixed part center pillar, and the fixed part cover panel;
the front body module further comprises a plurality of fixed part bulk heads mounted on an inner side of the fixed part closed-section and connected to the fixed part joints; and
the fixed part bulk heads are connected to the fixed part roof rail and the fixed part cover panel on an upper side of the front body module and are connected to the fixed part center pillar and the fixed part cover panel on a side of the front body module.
